(19) United States
(12) Patent Application Publication
(10) Pub. No.: US 2015/0167945 A1
(43) Pub. Date: Jun. 18, 2015

(54) Apparatus and Method for Providing Illumination

(71) Applicant: James Warren Neil, Melbourne, FL (US)

(72) Inventor: James Warren Neil, Melbourne, FL (US)

(21) Appl. No.: 14/104,192

(22) Filed: Dec. 12, 2013

(51) Int. Cl. F21V 23/00; F21K 99/00

(52) U.S. Cl. CPC F21V 23/003; F21K 9/10

(57) ABSTRACT

An apparatus for providing illumination having a plurality of series strings of serial light emitters having frequency spectrums, wherein at least two light emitters in a single series string have disparate frequency spectrums and rated forward voltages, the series strings are connected to one another in a parallel configuration, and the frequency spectrum of the light emitters combine to produce a target frequency spectrum.

### FIELD OF THE INVENTION

The present invention relates to the field of electric light bulbs. More specifically, the present invention relates to improved light bulbs that include light emitters of different wavelengths driven by a power source, without separate power regulators for each wavelength of light emitter.

### BACKGROUND OF THE INVENTION

The need for a more energy efficient electric light is clear. Although many attempts have been made to replace the incandescent lamp with LED technology, most are expensive, generate a great deal of heat, have poor omnidirectional light output, or fail to provide adequate spectral light output. Also, the smooth surface of incandescent light bulbs does not attract dirt and is easy to clean unlike the oddly shaped LED lamps offered with their convoluted heat sinks.

Existing LED replacement lamps typically use relatively few very bright LEDs operated at or near their electrical limit to generate sufficient light. This requires a power supply and separate heat sink. Because few individual light emitters are used the light is not radiated in an omnidirectional pattern, forcing awkward additions like reflecting fins, lenses, etc., in an attempt to overcome this shortcoming. For example, a table lamp fitted with a state of the current art LED bulb directs the majority of its light upward making it difficult to read or perform other tasks using such a lamp while sitting in a chair alongside the lamp. Additionally, few emitters may compromise possible improvements in color rendering. Although advances have been made in color temperature, color rendering may remain poor to unacceptable. Finally, few emitters concentrate not only the light but also the heat into a relatively small area, making it difficult to manage.

### SUMMARY OF THE INVENTION

With the foregoing in mind, embodiments of the present invention are related to an improved light emitting apparatus. Furthermore, the improved light emitting apparatus may advantageously combine several light emitters of different wavelengths. The use of several light emitters may allow each individual light emitter to be run undercurrent, thereby reducing or eliminating the need for heat dissipation while maintaining the overall brightness of the device. Additionally, the use of multiple wavelength light emitters may allow the apparatus to output a broad spectrum of light. The novel electrical configuration of the light emitters allows all light emitters, even those outputting disparate wavelengths to be connected to a single power source while maintaining an essentially steady output wavelength profile. That is, separately regulated power supplies are not required for LEDs outputting disparate wavelengths. LEDs outputting disparate wavelengths may be powered by a single power profile and maintain a relatively constant output of each wavelength relative to the other wavelengths present in the apparatus.

The light emitters of the inventive apparatus may be connected to one another in a series or parallel configuration driven by a single power source, even though they may output disparate wavelengths of visible light. A separate power supply is not required for each color light emitter because the configuration of the inventive apparatus maintains essentially the same relative outputs of different light emitters, even if the different light emitters have different frequency spectrums, even as the power supply undergoes anticipated, or normal, fluctuations in current or voltage. Additionally, it is not necessary to provide feedback controls to a power supply to compensate for frequency spectrum output variations that may occur as the temperatures of the light emitters fluctuate. Due to the novel configuration of the inventive apparatus, the temperature or voltage fluctuation affecting any light emitter may occur proportionally to other light emitters and, due to the electrical connections between light emitters, may not need to be tightly controlled. Additionally, the fluctuation occurring in a single light emitter may have a negligible effect on the overall frequency spectrum of the apparatus, due to the large number of light emitters utilized in the design, and therefore be unnecessary to tightly regulate.

These and other features and advantages according to an embodiment of the present invention are provided by electrically connecting multiple light emitters with different voltage thresholds in a series or parallel configuration as described herein.

### BRIEF DESCRIPTION OF THE DRAWINGS

FIG. 1 is a schematic diagram of one embodiment of the inventive apparatus.

FIG. 2 is a schematic diagram of one embodiment of the inventive apparatus.

FIG. 3 is a schematic diagram of one embodiment of the inventive apparatus.

FIG. 3a is a schematic diagram of possible embodiments of the inventive apparatus.

FIG. 4 is a schematic diagram of one embodiment of the inventive apparatus.

FIG. 5 is a schematic diagram of one embodiment of the inventive apparatus.

FIG. 6 is a schematic diagram of one embodiment of the inventive apparatus.

FIG. 7 is a schematic diagram of one embodiment of the inventive apparatus.

FIG. 8 is a schematic diagram of one embodiment of the inventive apparatus.

FIG. 9 is a schematic diagram of one embodiment of the inventive apparatus.

FIG. 10a is a diagram illustrating an exemplary output frequency spectrum.

FIG. 10b is a diagram illustrating an exemplary output frequency spectrum.

FIG. 10c is a diagram illustrating the addition of exemplary output frequency spectrums.

FIG. 11 is a diagram illustrating the addition of exemplary output frequency spectrums.

FIG. 12 is a flowchart illustrating the inventive method of designing the light emitting apparatus.

### DETAILED DESCRIPTION OF THE PREFERRED EMBODIMENT

The present invention will now be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Those of ordinary skill in the art realize that the following descriptions of the embodiments of the present invention are illustrative and are not intended to be limiting in any way. Other embodiments of the present invention will readily suggest themselves to such skilled persons having the benefit of this disclosure. Like numbers refer to like elements throughout.

In this detailed description of the present invention, a person skilled in the art should note that directional terms, such as “above,” “below,” “upper,” “lower,” and other like terms are used for the convenience of the reader in reference to the drawings. Also, a person skilled in the art should notice this description may contain other terminology to convey position, orientation, and direction without departing from the principles of the present invention.

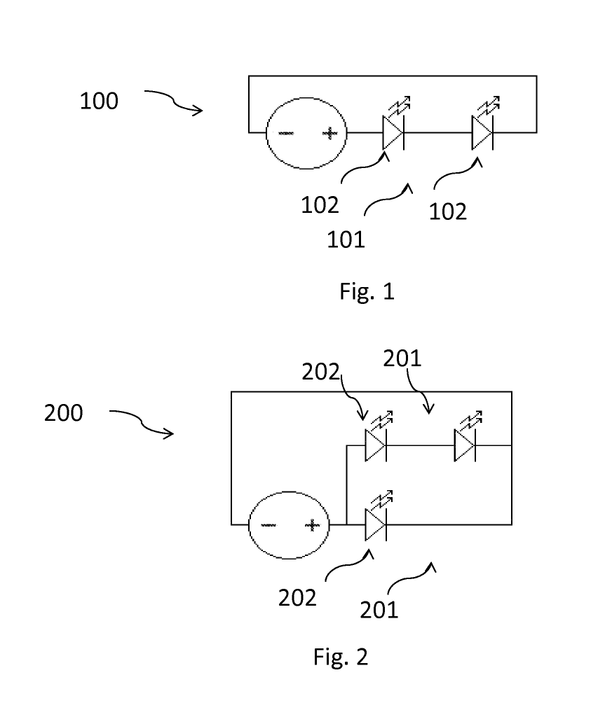

Referring to FIG. 1, which depicts a possible embodiment of the light emitting apparatus 100, a single series string 101 is shown comprising a plurality of light emitters 102. In the apparatus 100 shown in FIG. 1, two light emitters 102 are depicted in a single series string 101. A light emitter may be any devise that emits light, including, but not limited to light emitting diodes (LEDs), organic light emitting diodes (oLEDs), incandescent light bulbs, or other light producing devices capable of converting electricity to light. Each light emitter 102 has a frequency spectrum, which is the range of wavelength of the light emitted by the light emitter 102. The plurality of light emitters 102 comprising each series string 101 will be electrically connected in a serial configuration, as shown in FIG. 1. While FIG. 1 depicts exactly two light emitters 102 in a single series string 101, a plurality of light emitters 102 may be utilized to comprise a single series string 101.

The light emitters 102 may be operated below their respective rated forward voltages. This may allow the light emitter 102 to output significantly less heat and may significantly alleviate the need for heat dissipation from the apparatus 100. An effect of operating the light emitters 102 in under voltage conditions is that each light emitter 102 may produce less lumen. This may be addressed by increasing the total number of light emitters 102 utilized in the apparatus 100. The use of numerous light emitters 102 distributed over a relatively large area aids in heat dissipation and may alleviate the need for a heat sink. A power versus brightness balance may be reached when the generated heat is manageable without use of bulky heat sinks and the amount of light generated provides sufficient illumination. The ambient temperature of the operating environment and the forward current de-rating curves for the light emitters 102 may be utilized in achieving the power versus brightness balance.

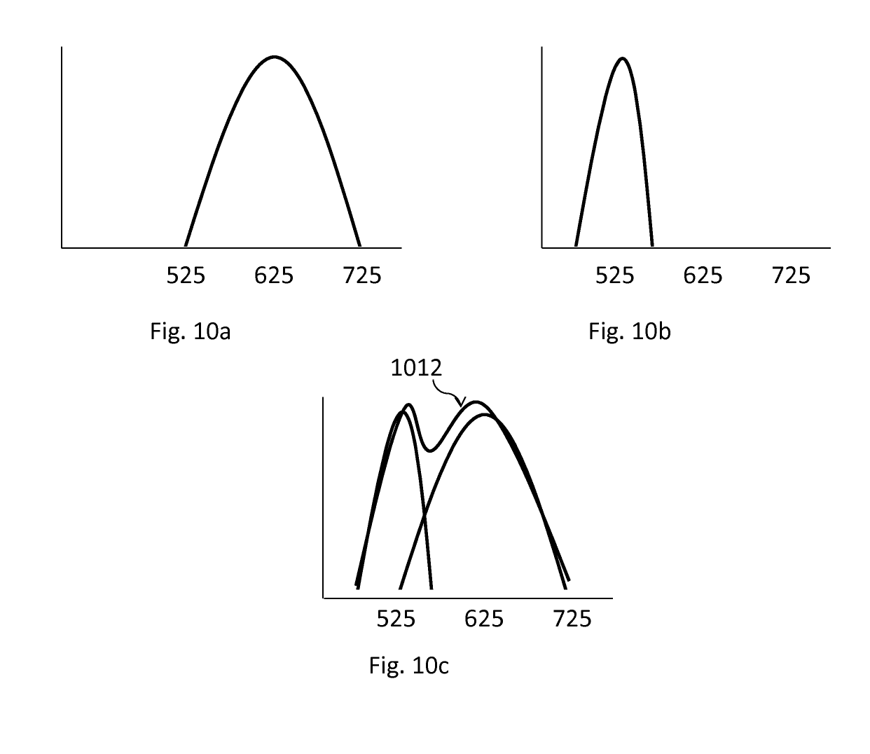

In one embodiment of the light emitting apparatus 100, at least two serial light emitters 102 may comprise a first series string 101. Each light emitter 102 will have a frequency spectrum. The frequency spectrums of the two serial light emitters 102 may be not be essentially equal to one another. For example, and not by way of limitation, the first serial light emitter may output a light that is essentially red, with a dominant wavelength of 625 nm. An exemplary frequency spectrum of such a light emitter is depicted in FIG. 10a. as the range of light that is output by the light emitter, but may be highest at 625 nm. Again, by way of example and not as a limitation, the second serial light emitter 102 may output a light that is essentially green, with a dominant wavelength of 525 nm. The frequency spectrum of such a light emitter will also be the range of light that is output by the light emitter, but may be highest at 525 nm, as depicted in FIG. 10b. Each light emitter 102 will also have a rated forward voltage. The rated forward voltage may be measured at a specified current draw. The rated forward voltage may be the typical forward voltage of a light emitter 102 as measured under a specified current draw. By way of example, and not by way of limitation, the specified current draw may be 20 mA. In such an example, the exemplary rated forward voltage of an exemplary red light emitter 102 may be 2.0 V and the exemplary forward voltage of an exemplary green light emitter 102 may be 3.2 V.

The apparatus 100 may be made up of light emitters 102 of multiple colors in various combinations to produce light of any desired target frequency spectrum, including, but not limited to any desired color, part or parts of the visible color spectrum, the full visible color spectrum, or the like. It may be beneficial to utilize a variety of light emitters outputting a variety of frequency spectrums as a goal may be to provide light at all visible wavelengths for the best possible color rendering.

In one embodiment of the inventive apparatus 100, the frequency spectrums or rated forward voltages of one or more of the light emitters 102 connected in a serial configuration may be disparate.

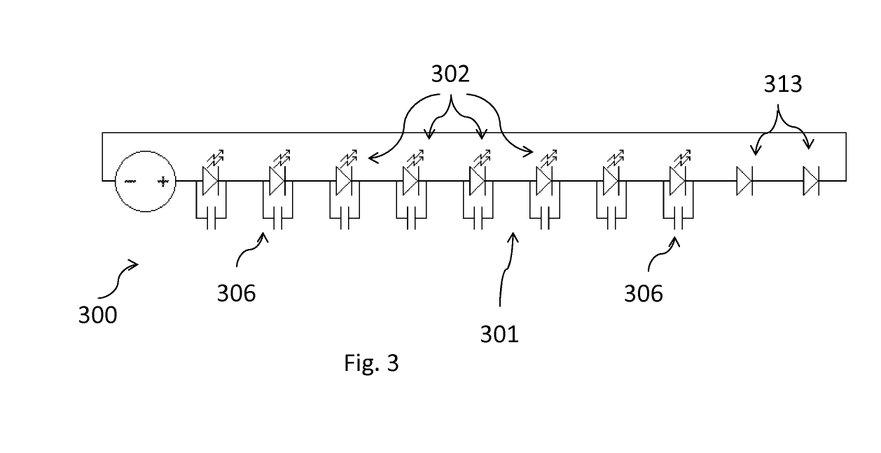

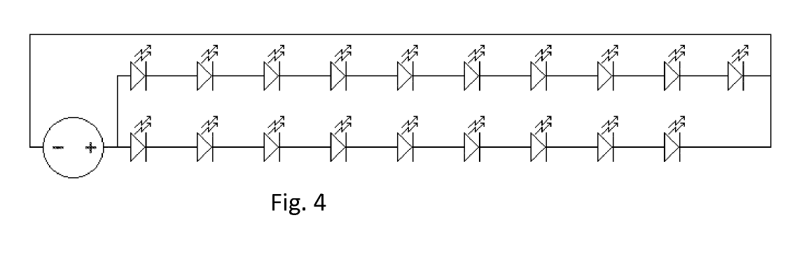

FIG. 2 depicts an embodiment of the apparatus 200, in which there are two series strings 201. In embodiments with at least two series strings 201, each series string may be electrically connected to one or more other series strings 201 in a parallel configuration. In such a configuration, the voltage drop across each series string 201 will be equal to the voltage drop across other series strings 201 to which it is electrically connected in a parallel configuration. Utilizing such a configuration will cause the light emitters 202 in each series string to draw current proportionally to the other series strings 201 to which they are connected in parallel. In a configuration utilizing more than one series string 201 connected in parallel, it is not required that each series string 201 have the same number of light emitters. Such a configuration is shown in FIGS. 2 and 4.

Each series string 201 has a series rated forward voltage equal to the sum of the rated forward voltages of each of the light emitters 201 or adjusting diodes in the series string 201. The series rated forward voltages of different series strings 201 which are connected in parallel may be unequal. However, when such series strings 201 are connected in parallel with one another, the actual voltage drop across the series strings 201 will be equal.

Each series string 201 has a series frequency spectrum equal to the sum of the frequency spectrums of each of the light emitters 202 in the series string 201. The series frequency spectrum of different series strings 201, which may be connected in parallel, may be unequal.

Each apparatus 200 may be connected to a power supply, which has a voltage and current profile (collectively, “power profile”). Often times, when driving LEDs, a power supply is regulated to provide voltage and current profiles to the LED which remain within tight tolerances. In some existing LED configurations, the relative brightness of LEDs with different frequency spectrums are tightly controlled by regulated power supplied to each LED and specifically by providing disparate power profiles to LEDs with disparate frequency spectrums or rated forward voltages. In the inventive apparatus 200, at least one light emitter 202 in each of the plurality of series strings 201 may receive the identical current and voltage profile from a power source. Each light emitter 202 in the apparatus 200 may receive the same current profile, modulated only by other light emitters or adjusting diodes in the apparatus 200. It may be unnecessary to regulate power independently for each series string 201. According to the inventive apparatus 200, it is not necessary to provide separate power profiles to light emitters 202 with disparate rated forward voltages or frequency spectrums. Rather, the electrical configuration of the inventive apparatus 200 operates to maintain relative brightness of disparate light emitters 202 within tolerances deemed suitable to maintain pleasing task, decorative, or functional lighting. Therefore, power regulators are not required in the inventive apparatus 200. Without separate power regulators for each group of light emitters 202 outputting a particular frequency spectrum the apparatus 200 may still maintain the target frequency spectrum output.

Utilizing the inventive configuration of light emitters 202, each light emitter 202 in a particular series string 201 may receive essentially the same current profile, while the voltage drop across each light emitter 202 may vary based upon characteristics inherent to the light emitter 202. Light emitters 202 with characteristics which produce different voltage drops across the light emitter 202 may be freely mixed within any series string 201. Adding additional light emitters 202 to a series string 201 may reduce the current to all light emitters 202 in the series string 201 by a small amount, while subtracting light emitters 202 may increase the current to all light emitters 202 in the series string 201. The current level required by the light emitters 202 to achieve the desired power versus brightness balance may be determined by choosing the correct number and combination of light emitters 202 in a series string 201 to match the voltage supplied by the desired power supply. An apparatus 200 that will be supplied by a higher voltage supply may require more light emitters 202 than one that will be supplied by a lower voltage supply. Alternatively, an apparatus 200 that may be supplied by a higher voltage supply may utilize light emitters 202 that have a higher voltage drop than one that is supplied by a lower voltage supply. The quantity of each light emitter 202 utilized in the apparatus with a specific frequency spectrum determines the overall frequency spectrum of the apparatus 200, so frequency spectrum of light emitters 202 must be considered in addition to voltage drop across the light emitters 202 when designing the apparatus 200. As the selection of voltage drop across a light emitter 202 is related to the frequency spectrum output of the light emitter 202, it may be important to note that it is not necessary for each individual series string 201 to match the target frequency spectrum. However, the combination of the frequency spectrums of all series strings 201 in the apparatus 200 should match, or approximate, the target frequency spectrum.

The frequency spectrum of each light emitter 202 in the configuration may optically combine with the frequency spectrums of the other light emitters in the configuration to produce a target frequency spectrum. FIG. 10c depicts a possible embodiment utilizing two light emitters, one with a frequency spectrum centered on 525 nm and the other with a frequency spectrum centered on 625 nm. The target frequency spectrum 1012 is obtained by adding the individual frequency spectrums of the light emitters 202. Light emitters 202 capable of producing light at evenly spaced wavelengths in the visible spectrum, such that their relative light intensity profiles overlap enough to ensure full coverage may be desirable, but a close approximation is sufficient to obtain good results. The amount or intensity of each frequency spectrum is controlled by the ratio of the number of light emitters 202 outputting the frequency spectrum compared to those emitting other frequency spectrums. If the light output of the light emitters 202 of different frequency spectrums is not sufficiently balanced to achieve good color rendering properties, adding more light emitters 202 of the frequency spectrum in which there is a deficit may aid in bringing the apparatus 200 into color balance. The amount of light of each frequency spectrum is controlled by the quantity of light emitters 202 outputting that frequency spectrum, as well as the current drawn by the light emitters 202. This precludes the need for any kind of control over the power supplied to light emitters 202 of disparate frequency spectrums.

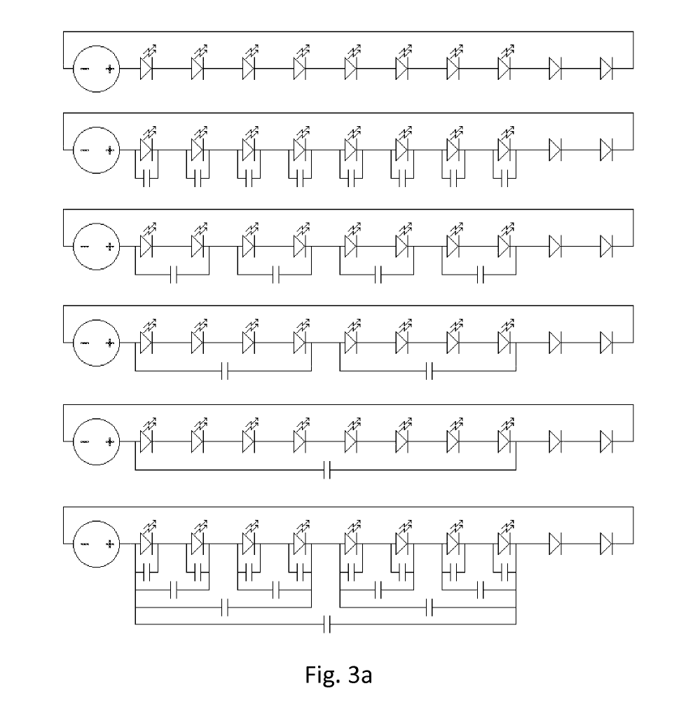

Turning to FIG. 3, a single series string 301 is depicted with multiple light emitters 302. Electrically connected in a series configuration with the light emitters 302 are adjusting diodes 313. As shown in FIG. 3, there are two adjusting diodes 313. However, the number of adjusting diodes 313 may be altered to adjust the voltage drop across the entire series string. The adjusting diodes 313 may not emit light or may not emit visible light. By adding adjusting diodes 313 to the apparatus 300 configuration, the current drawn by the series string 301 may be adjusted to decrease the brightness of the frequency spectrum output by each light emitter 302 in the series string 301. Removal of adjusting diodes 313 may result in an increase in the brightness of the frequency spectrum output by each light emitter 302 in the series string 301.

According to the embodiment depicted in FIG. 3, one or more of the light emitters 302 may have disparate serial rated forward voltages. Additionally, one or more of the adjusting diodes 313 may have disparate forward voltages. Generally, the adjusting diodes 313 may have smaller serial rated forward voltages than the light emitters 302. The inclusion of adjusting diodes 313 may allow the brightness of the series strings 301 and the overall apparatus 300 to be more accurately controlled.

In one embodiment of the inventive apparatus 300, a plurality of capacitors 306 may be electrically connected to the input of a plurality of light emitters 302. Separate capacitors 306 may be connected to the input of each light emitter 302 or capacitors 306 may be connected to the inputs of groups of light emitters 302. FIG. 3a depicts possible embodiments of the inventive apparatus including capacitors.

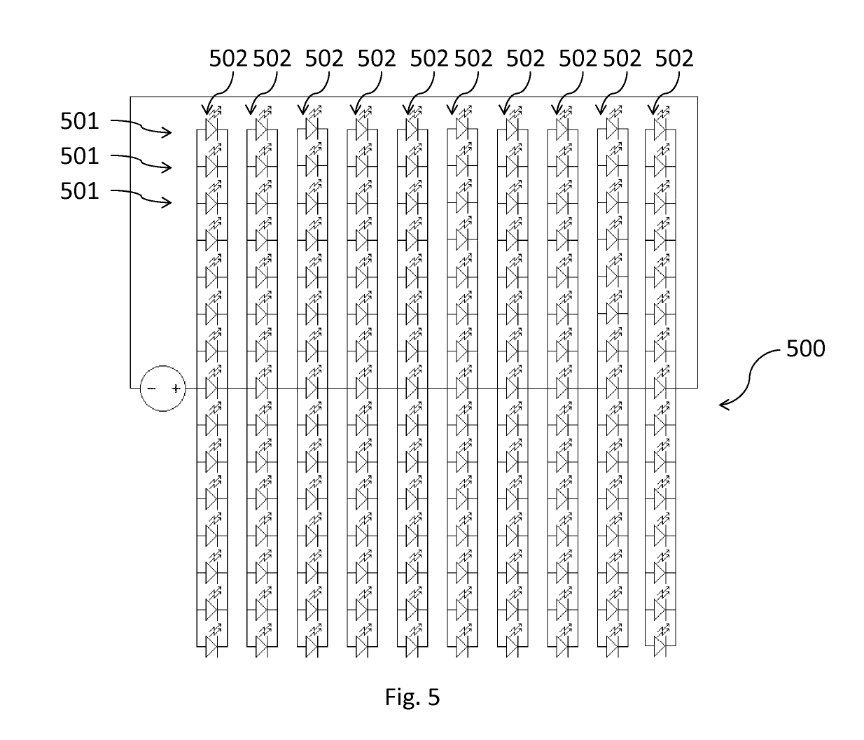

FIG. 5 depicts an embodiment of the inventive apparatus 500 in which there are multiple series strings 501 and each of the series strings 501 has the same number of light emitters 502 as the other series strings 501. In the embodiment depicted in FIG. 5, each of the light emitters 502 is connected in parallel with exactly one light emitter 502 from each of the series strings 501 and each series string 501 is connected in parallel with each other series string 501.

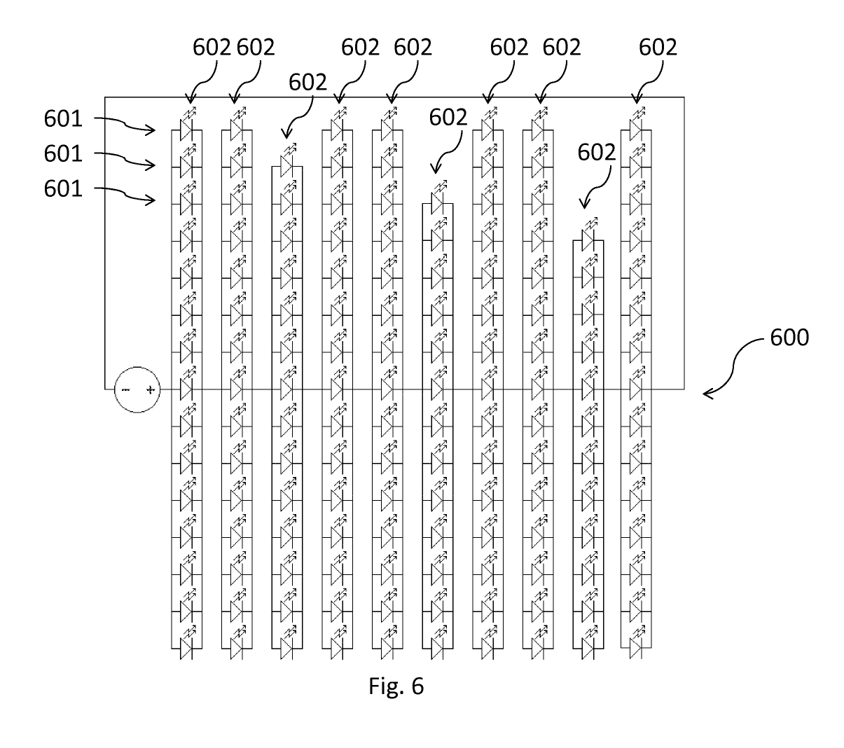

FIG. 6 depicts an embodiment of the inventive apparatus 600 in which multiple series strings 601, having disparate numbers of light emitters 602, are connected in parallel with one another. As shown in FIG. 6, each light emitter 602 is connected in series with the other light emitters 602 in the same series string 601 and also connected in parallel with light emitters 602 in other series strings 601. As depicted in FIG. 6, by way of example, and not as a limitation, the series strings 601 have between seven and ten light emitters 602.

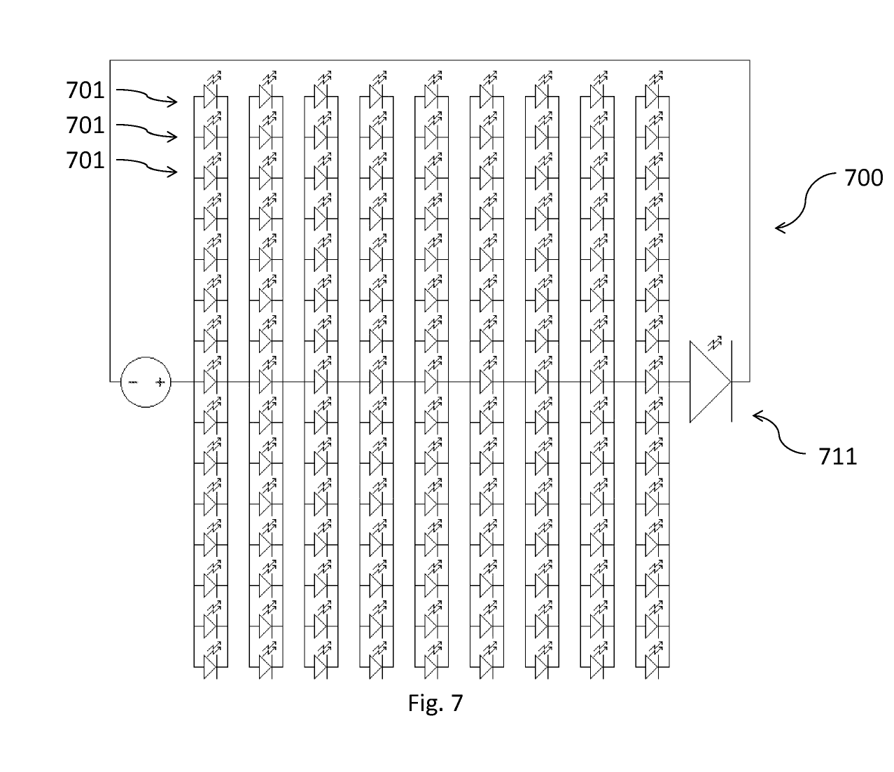

FIG. 7 depicts an embodiment of the apparatus 700 in which a bulk light emitter 711 is connected in series with each of the series strings 701. In such an embodiment, a plurality of series strings 701 may electrically connect to a bulk light emitter 711 in a configuration that provides the current flowing through each of the series strings 701 to combine and flow through the bulk light emitter 711.

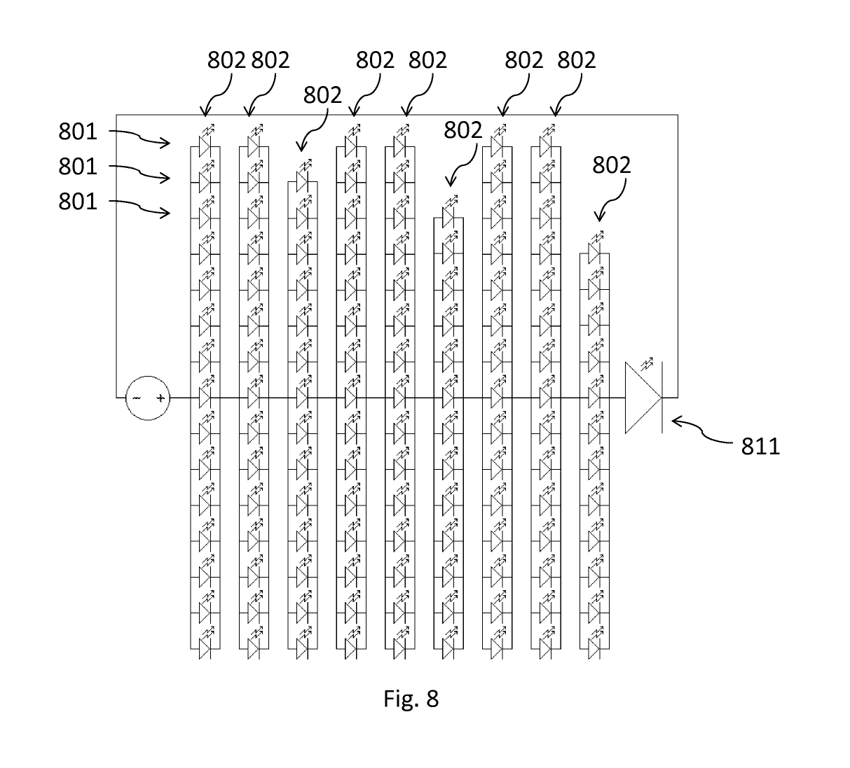

FIG. 8 depicts an embodiment in which each of the serial light emitters 802 are connected in a parallel configuration and a bulk light emitter 811 is connected in series with the output of the parallel connected series strings 801. Not depicted, but also disclosed is the related configuration in which the current output of the bulk light emitter 811 may be connected to the input of each series string 801.

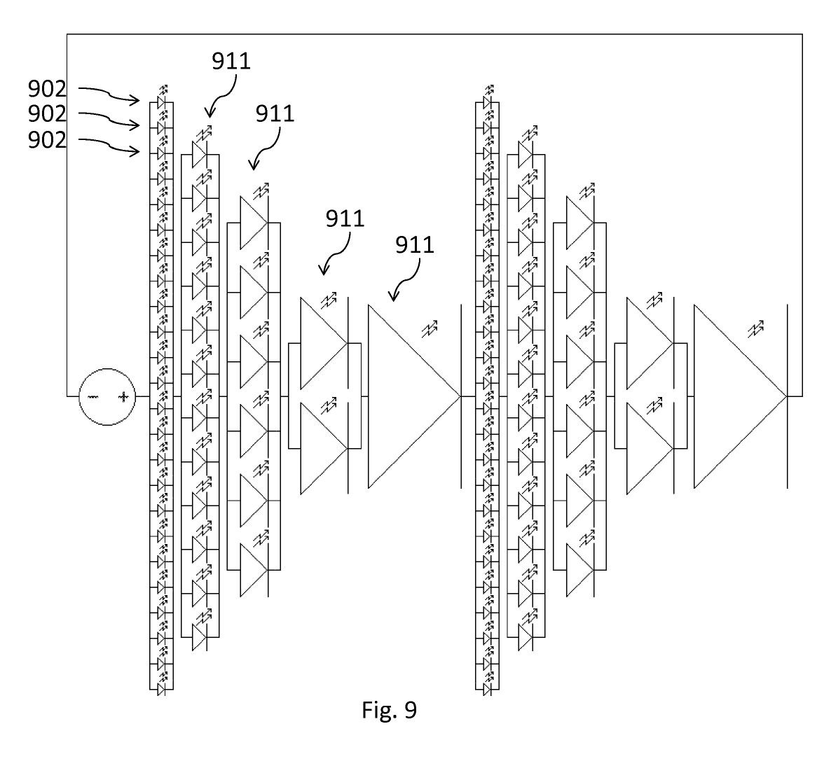

FIG. 9 shows yet another embodiment of the apparatus in which bulk light emitters 911 may be utilized. In such an embodiment, light emitters 902 connected in parallel with other light emitters 902 of similar current draw for rated forward voltage may combine output current to feed into a fewer number of bulk light emitters 911, each with a larger current draw than the multiple light emitters 902 providing current to the bulk light emitter 911 or receiving current from the bulk light emitters 911.

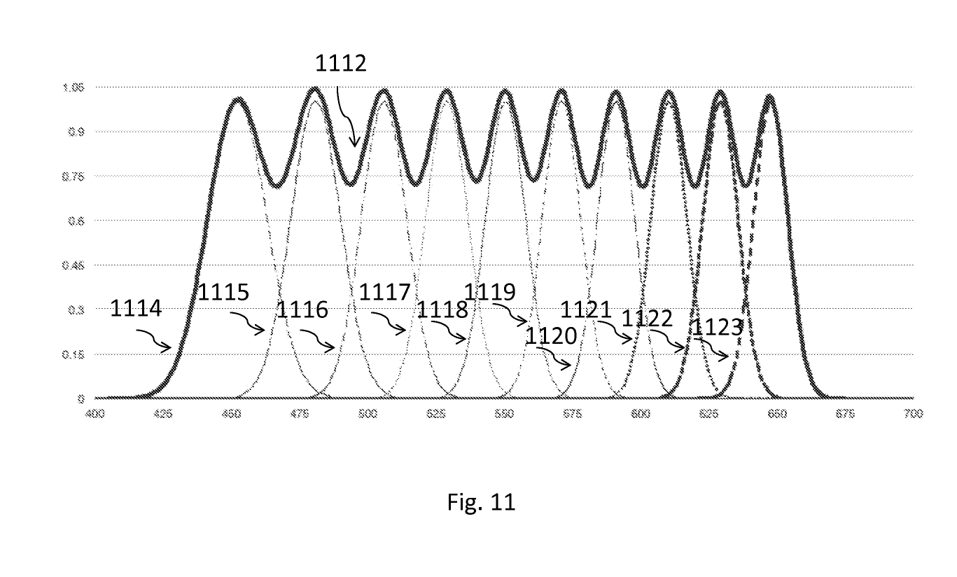

FIG. 11 shows the addition of frequency spectrums from 10 different light emitters. Each light emitter outputs a frequency spectrum 1114-1123. As shown in FIG. 11, some of these individual frequency spectrums 1114-1123 may overlap. The addition of each individual frequency spectrum 1114-1123 results in the target frequency spectrum 1112. The dips in the target frequency spectrum 1112 may be filled in, if desired, by adding additional light emitters that provide a frequency spectrum output at the location of the dip in the target frequency spectrum 1112.

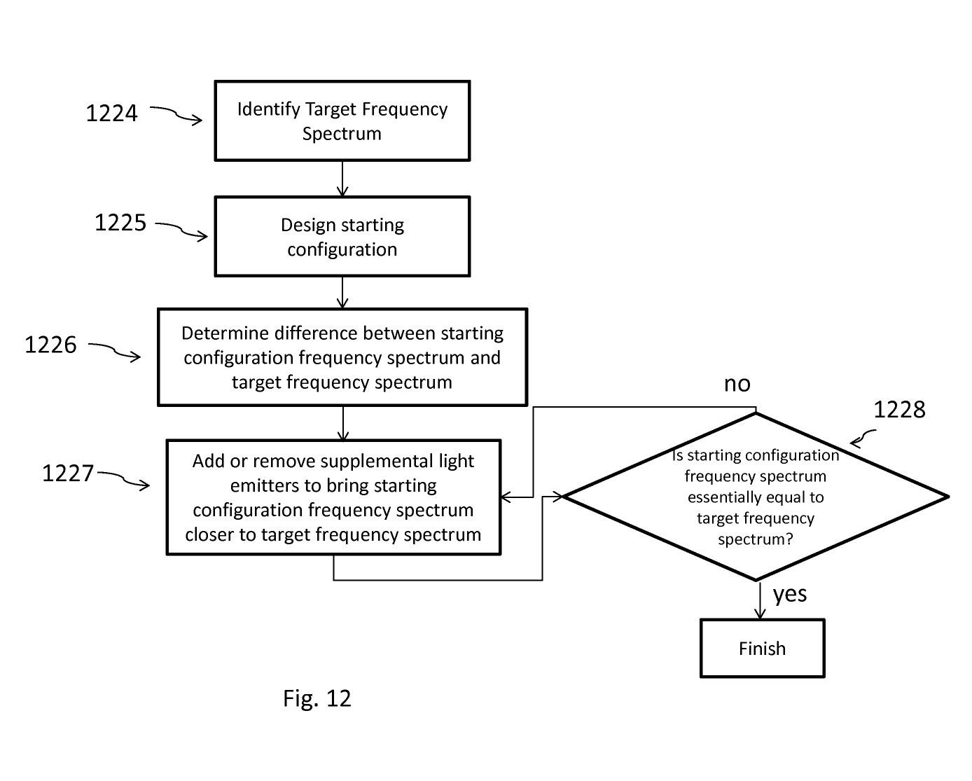

FIG. 12 shows an embodiment of a method for emitting illumination. A target frequency spectrum may be identified 1224. This target frequency spectrum may approximate the frequency spectrum of a black body radiator or any other desired light output. A starting configuration may then be selected 1225. The starting configuration may be any collection of light emitters electrically connected to one another in accordance with the disclosure directed to the inventive apparatus. The starting configuration will have a starting frequency spectrum equal to the combination of the frequency spectrums of each light emitter utilized in the starting configuration. The starting frequency spectrum may be compared to the target frequency spectrum to determine where gaps in frequency spectrum occur or to determine where the starting frequency spectrum may include too much of a specific wavelength 1226. The difference between the frequency spectrum of the starting configuration and the target frequency spectrum may determine the frequency deficiency. A plurality of supplemental light emitters may be connected to the starting configuration in accordance with one of the embodiments of the inventive apparatus 1227. The selection and configuration of the supplemental light emitters may be based upon the frequency deficiency with the supplemental light emitters providing output frequencies that may be missing from the target frequency spectrum. The supplemental light emitters may be electrically connected to the starting configuration according to the disclosure of the inventive apparatus in such a way as to bring the starting frequency spectrum closer to the target frequency spectrum when the supplemental frequency spectrum is added to the starting frequency spectrum. Additionally, supplemental light emitters may be removed from the configuration as necessary to bring the frequency spectrum output by the apparatus closer to the target frequency spectrum while still maintaining the electrical properties dictated by the inventive apparatus. Supplemental light emitters may continue to be added or removed until the starting configuration frequency spectrum is essentially equal to or approximates the target frequency spectrum within acceptable tolerances 1228.

Each supplemental light emitter added to the starting configuration may be powered by the same power source provided to the starting configuration, with no need to regulate the power to the supplemental light emitters according to characteristics inherent to the light emitters. The starting configuration or supplemental light emitters may be supplied with a current less than that for which the light emitter may be rated or less than that at which the light emitter may operate most efficiently.

A person of skill in the art will appreciate that one or more of the above provided embodiments may be included in designing the light emitting apparatus of the present invention. Additionally, a person of skill in the art will appreciate additional embodiments that would be included within the scope and spirit of the present invention, after having the benefit of this disclosure. Furthermore, a skilled artisan will appreciate that the operations described above, along with additional operations that would be apparent to those in the art, may be performed exclusively, incrementally, sequentially, simultaneously, or any other operative configuration.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

1. An apparatus for providing illumination comprising:
at least one series string comprising at least one serial light emitter having a frequency spectrum;
wherein each of the at least one serial light emitter are electrically connected in a serial configuration;
wherein the at least one series string further comprises a first series string wherein the first series string comprises at least two serial light emitters;
wherein the at least two serial light emitters further comprise a first serial light emitter and a second serial light emitter;
wherein the first serial light emitter has a first serial frequency spectrum and a first serial rated forward voltage at a specified current draw;
wherein the second serial light emitter has a second serial frequency spectrum and a second serial rated forward voltage at the specified current draw;
wherein the first serial frequency spectrum is not essentially equal to the second serial frequency spectrum;
wherein each of the at least one series string are electrically connected to one another in a parallel configuration;
wherein the first serial rated forward voltage is not essentially equal to the second serial rated forward voltage; and
wherein the frequency spectrums of each of the at least one serial light emitter optically combine to produce a target frequency spectrum.

2. The apparatus according to claim 1 further comprising a first series string; and
a second series string;
wherein each of the at least one series string may be connected to a power source having a voltage profile and a current profile;
wherein the voltage profile and current profile are electrically presented to one of the at least one serial light emitter in the first series string; and
wherein the voltage profile and current profile are electrically presented to one of the at least one serial light emitter in the second series string.

3. The apparatus according to claim 2 further comprising an at least one capacitor wherein each of the at least one capacitor is electrically connected to each of the at least one serial light emitter and wherein the voltage and current profile are electrically present to each of the at least one capacitor.

4. The apparatus according to claim 1 further comprising an at least one adjusting diode;
wherein the at least one adjusting diode does not emit visible light; and
wherein the at least one adjusting diode are electrically connected in a series
configuration with the at least one light emitter.

5. An apparatus for providing illumination comprising:
an at least one series string comprising an at least one serial light emitter having frequency spectrums and serial rated forward voltages at a specified current draw, wherein the at least one serial light emitter are connected in a series configuration;
wherein the at least one series string further comprises a first series string wherein the first series string comprises at least two serial light emitters, wherein the at least two serial light emitters further comprise a first serial light emitter and a second serial light emitter, wherein the at least two serial light emitters are electrically connected in a series configuration;
wherein the first serial light emitter has a first serial frequency spectrum and a first serial rated forward voltage at the specified current draw;
wherein the second serial light emitter has a second serial frequency spectrum and a second serial rated forward voltage at the specified current draw;
wherein each of the at least one series string are electrically connected to one another in a parallel configuration;
wherein each of the at least one series string may have a different number of the at least one serial light emitter;
wherein each of the at least one series string has a series rated forward voltage equal to the sum of the serial rated forward voltages of each of the at least one serial light emitter;
wherein each of the at least one series string has a series frequency spectrum equal to the sum of the frequency spectrums of each of the at least one light emitter;
wherein the frequency spectrums of each of the series frequency spectrums optically combine to produce a target frequency spectrum.

6. The apparatus according to claim 5 further comprising a first series string having a first serial frequency spectrum;
and a second series string having a second serial frequency spectrum;
wherein the first serial frequency spectrum is not essentially equal to the second serial frequency spectrum.

7. The apparatus according to claim 5 further comprising a first series string having a first serial rated forward voltage at the specified current draw; and
a second series string having a second serial rated forward voltage at the specified current draw;
wherein the first serial rated forward voltage is not essentially equal to the second serial rated forward voltage.

8. The apparatus according to claim 5 wherein the serial rated forward voltage of at least one of the at least one series string may be disparate.

9. The apparatus according to claim 5 wherein each of the at least one series string has an identical number of the at least one light emitter; and
wherein each of the at least one light emitter is electrically connected in a parallel configuration with exactly one of the of least one serial light emitter in each of the other at least one serial string.

10. The apparatus according to claim 5 further comprising a first series string; and
a second series string;
wherein each of the at least one series string may be connected to a power source having a voltage profile and a current profile;
wherein the voltage profile and current profile are electrically presented to one of the at least one serial light emitter in the first series string; and
wherein the voltage profile and current profile are electrically presented to one of the at least one serial light emitter in the second series string.

11. The apparatus according to claim 9 further comprising an at least one bulk light emitter having a bulk light emitter current draw; wherein the at least one bulk light emitter are connected in a series configuration with at least one of the at least one series string.

12. The apparatus according to claim 9 wherein at least one bulk light emitter are electrically connected in a series configuration with each of the at least one series string.

13. The apparatus according to claim 5 wherein each of the at least one light emitter is electrically connected in a parallel configuration with at least one of the at least one serial light emitter in at least one other of the at least one serial string.

14. The apparatus according to claim 13 further comprising at least one bulk light emitter having a bulk light emitter current draw; wherein the at least one bulk light emitter are connected in a series configuration with a at least one of the at least one series string.

15. The apparatus according to claim 13 wherein the at least one bulk light emitter are electrically connected in a series configuration with each of the at least one series string.

16. The apparatus according to claim 5 further comprising a at least one adjusting diode;
wherein the at least one adjusting diode does not emit visible light; and
wherein the at least one adjusting diode are electrically connected in a series configuration with the at least one light emitter.

17. (canceled)

18. (canceled)

19. (canceled)

20. (canceled)
